(19) United States
(12) Patent Application Publication
(10) Pub. No.: US 2009/0197777 A1
(43) Pub. Date: Aug. 6, 2009

(54) METHOD OF MAKING AND USING MICROARRAYS SUITABLE FOR HIGH THROUGHPUT DETECTION

(76) Inventors: Alexander Chagovetz, Salt Lake City, UT (US); Steve Blair, Salt Lake City, UT (US); Colby Wilson, Salt Lake City, UT (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/191,134

(22) Filed: Aug. 13, 2008

Related U.S. Application Data
(60) Provisional application No. 60/964,661, filed on Aug. 13, 2007.

(51) Int. Cl. C40B 40/04; B44C 1/22

(52) U.S. Cl. 506/15; 216/94

(57) ABSTRACT

Disclosed are high density microarrays and methods for making and using such microarrays. The microarrays of the present invention can have uniformly shaped and sized sensing zones and are designed to allow high-throughput detection assays with minimal noise.

### CROSS-REFERENCE TO RELATED PATENT APPLICATIONS

This application claims priority to U.S. Provisional Application No. 60/964,661 titled Method of Making Microarrays Suitable for High-Throughput Detection, filed on Aug. 13, 2007. In their entirety, the contents of this provisional application are herein incorporated into this non-provisional application.

### BACKGROUND OF THE INVENTION

Microarrays are a powerful tool for obtaining quantitative and qualitative information about the composition of samples, particularly from biological sources such as tissues, cells, or viruses. Further, such systems also provide the ability to conduct a large number of parallel analyses on a single small platform. The basic concept behind microarray analysis is to create an addressable interrogation space in which specific addressable units (sensing zones) interact with specific components of a sample and produce a signal that provides information about the identity and quantity of those components. To this end, such microarrays have from hundreds to millions of sensing zones arranged on a support measuring several square centimeters, such as a glass slide. When a sample is introduced to the microarray, chemical or physical interactions between labeled target molecules and the functional surface in particular sensing zones cause these molecules to be immobilized in the zones. Known techniques may then be used to locate the labeled molecules of interest within the microarray. One such detection method involves labeling target molecules with fluorescent labels, so that irradiation of the array with light having the appropriate wavelengths induces fluorescence that can be detected and quantified.

Microarrays make possible the parallel processing of large amounts of molecular data on a single platform. High-density microarrays, having hundreds of thousands of sensing zones, greatly increase this informational capacity without a concomitant increase in platform size. However, a concern with using microarrays, particularly high-density microarrays, is that poor addressability can result due to the extremely small spaces between zones. In high-density microarrays, these interstices can be very small (less than 100 microns), so even limited binding in these areas can produce poor detection signal-to-background signal ratios, reducing the sensitivity of the assay. Therefore, it is increasingly important to reduce these unwanted phenomena by strictly controlling the characteristics of the interstices.

Thus, there is a need in research and clinical applications to develop very high-density microarrays with millions of sensing zones per standard microscope slide (7.5 cm×2.5 cm) or other custom formats. One of the limiting factors in the fabrication of high-density arrays is the uncertainty of the size distribution of sensing zones, which leads, in turn, to possible cross-talk between adjacent zones. By using photolithography, the prefabrication of the shapes of the sensing zones in a thin film cladding on the substrate with desired geometry is possible, and allows for an increase in the density of the sensing zones and improvement in the quantitative response (reproducibility) of the microarrays. In Dufva (Fabrication of High Quality Microarrays; Biomolecular Engineering, 22: 173-184, 2005) insight into the various factors and parameters affecting fabrication of microarrays is given. In their entirety, the contents of Dufva are herein incorporated into this application.

Morphology of the surface features in bio or chemical sensing is a critical parameter defining mass transport and kinetics of surface chemistry interactions. Thus, maintaining reproducible morphology of the sensing zones of a particular architecture is a prerequisite to obtaining quantitatively reproducible results for a broad range of comparative studies. Current approaches rely on accuracy of chemical reaction conditions (concentrations, volumes, time of exposure), which can be (and often are) automated. However, uncertainties with surface preparation (e.g., roughness, hydrophobicity, uniformity of functional modifications) and mass transport effects make this task challenging when the characteristic size of the feature is very small (less than 10 μm) or very big (˜100 μm). Particularly important are the effects of crosstalk between the features in the high-density format, where molecular features destined to one address on the surface may react with the proximal secondary zones.

### BRIEF DESCRIPTION OF THE FIGURES

FIG. 1 shows that by utilizing positive or negative photoresist, the shapes of the sensing zones may be represented as openings or windows in the film of cladding (i.e., “wells”), or as discs on the surface of the substrate (i.e., “islands”) as demonstrated here.

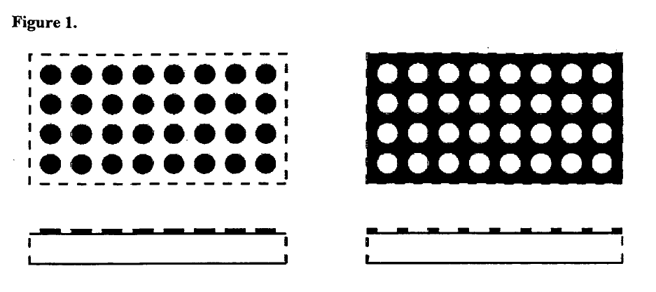

FIG. 2 shows an image of a fabricated substrate with openings etched into a metal (Al) cladding layer.

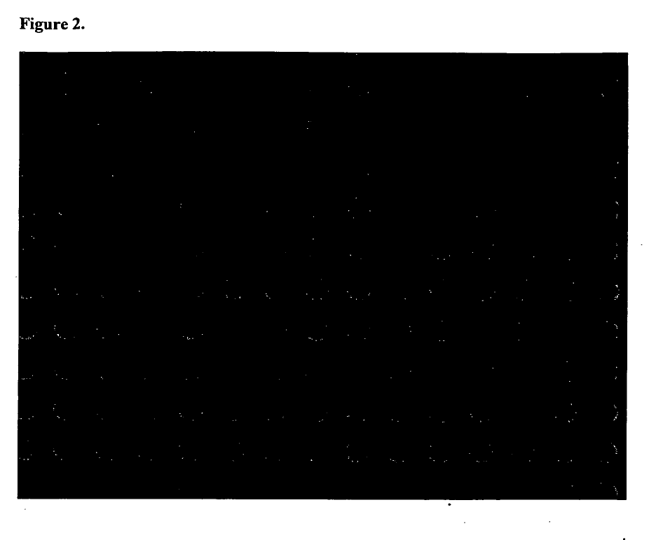

FIG. 3 shows a raw fluorescence image of uniform sensing zones upon immobilization of fluorescently-labeled probe DNA onto a fabricated substrate with openings in a metal cladding layer.

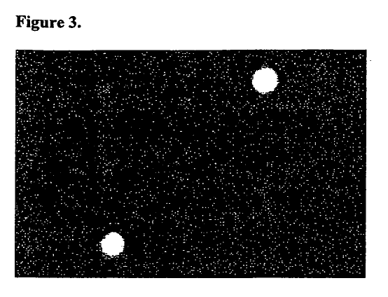

FIG. 4 shows an illustration of the use of hydrogel films on the surface of the substrate to create desired shapes and sizes of the sensing zones

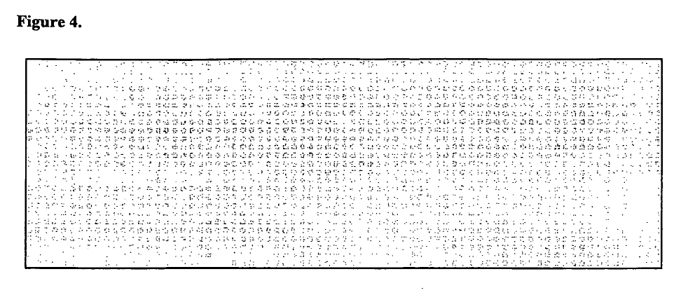

FIG. 5 shows an illustration of another preferred embodiment in which an array of small particles is created within a disc region (“islands”) or an array of small holes (“wells”) is created within a window.

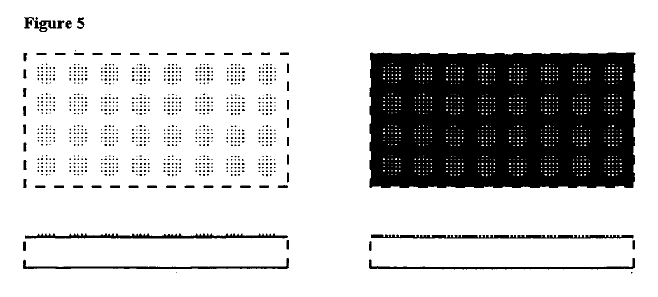

### SUMMARY OF THE INVENTION

It would be desirable to prepare microarrays that can optionally have uniformly shaped and sized sensing zones, and that are designed to allow high-throughput detection assays with minimal noise.

In one aspect, a method of making a microarray comprises (a) depositing a cladding layer material onto a substrate so as to create a cladding layer thereupon; (b) etching an array of sensing zones into the cladding layer, each of which is a shaped zone of exposed substrate; and (c) applying a ligand to the array of sensing zones, wherein the ligand is configured to bind to the substrate but not to the cladding layer material, so that bound ligand is substantially confined to the sensing zones and the cladding layer remains substantially free of bound ligand.

In another aspect, a method of making a microarray comprises (a) providing a substantially transparent substrate; (b) depositing a cladding layer material onto the upper surface of the transparent substrate so as to create a cladding layer thereupon; (c) etching an array of sensing zones into the cladding layer, each of which is a shaped zone of exposed substrate; (d) applying a ligand having a photolabile functional group to the array of sensing zones, and (e) irradiating the lower surface of the substrate with radiant light energy, causing ligand in the sensing zones to bind to the upper surface, wherein the bound ligand is substantially confined to the sensing zones and the cladding layer remains substantially free of bound ligand.

In another aspect, a method of making a microarray comprises (a) depositing a cladding layer onto a substrate; (b) patterning an array of sensing zones onto the cladding layer; (c) removing the cladding layer outside of the sensing zones to expose the underlying substrate, so that each sensing zone comprises a discrete area of cladding layer material surrounded by exposed substrate; and (d) applying a ligand to the array of sensing zones, wherein the ligand is configured to bind to the cladding layer material but not to the substrate material, so that bound ligand is substantially confined to the sensing zones and the substrate remains substantially free of bound ligand.

Also disclosed herein are microarrays that can be prepared in accordance with the above-described methods, or other similar methods. For example, in this aspect, a microarray comprises a substrate, a cladding material, and a ligand. The cladding material can be deposited on the substrate in the form of an array of discontinuous islands of cladding material substantially isolated from one another by the substrate. The ligand can have a basal functional group and an apical functional group attached to the islands, wherein the basal functional group is configured to bind to the cladding material but not to the substrate so that bound ligand is substantially confined to the islands and the substrate remains substantially free of bound ligand.

In another aspect, the microarray comprises a cladding material deposited on the substrate in the form of a continuous layer of cladding material that laterally defines an array of discontinuous wells, wherein a base portion of said wells includes the substrate. In this embodiment, the ligand can have a basal functional group and an apical functional group attached to the wells, wherein the basal functional group is configured to bind to the substrate but not to the cladding layer material so that bound ligand is substantially confined to the sensing zones and the cladding layer remains substantially free of bound ligand.

In another aspect, the microarray comprises a cladding material deposited on the substrate in the form of a continuous layer of cladding material that laterally defines an array of discontinuous wells, wherein a base portion of said wells includes the substrate. In this embodiment, the ligand can have a basal functional group and an apical functional group attached to the wells, wherein the basal functional group is configured to bind to the substrate but not to the cladding layer material so that bound ligand is substantially confined to the sensing zones and the cladding layer remains substantially free of bound ligand. Here, the ligand further comprises a photolabile functional group that requires radiant light energy in order to bind to a surface.

It is noted that these microarrays can have all of the design features and/or material described in accordance with the methods herein.

Also disclosed herein are methods for using said microarrays to obtain quantitative and qualitative information about the composition of a sample.

### DETAILED DESCRIPTION OF THE INVENTION

### A. Definitions

It is to be noted that, as used in this specification and the appended claims, the singular forms “a,” “an,” and “the” include plural referents unless the context clearly dictates otherwise.

The term “target molecule” refers to a molecule of interest in the sample. The terms “target molecule” and “molecule of interest” may be used interchangeably.

The term “photoresist” refers to a light-sensitive material used in several industrial processes, such as photolithography and photoengraving to form a patterned coating on a surface. Traditionally, photoresists are divided into two groups—positive resists and negative resists. A positive resist is a type of photoresist in which the portion of the photoresist that is exposed to light becomes soluble to the photoresist developer and the portion of the photoresist that is unexposed remains insoluble to the photoresist developer. A negative resist is a type of photoresist in which the portion of the photoresist that is exposed to light becomes relatively insoluble to the photoresist developer. The unexposed portion of the photoresist is dissolved by the photoresist developer.

The terms “ligand” refers to a molecule that serves to bind the target molecule or molecule of interest. Ligands include but are not limited to DNA, RNA, PNA, LNA, and other modified synthetic or naturally occurring nucleic acids, peptides, proteins including antibodies, glycans, fatty acids, enzyme substrates, activators or inhibitors.

The term “organosilanes” refers to organic compounds that are known as coupling agents or adhesion promoters. More generally, a silane is any silicon analogue of an alkane hydrocarbon. Silanes consist of a chain of silicon atoms covalently bound to hydrogen atoms. The general formula of a silane is SiₙH₂ₙ₊₂. Silanes tend to be less stable than their carbon analogues because the Si—Si bond has a strength slightly lower than the C—C bond.

The term “translucent” refers to a material through which light may be passed, but in which the light is diffused to a greater than extent than light is diffused through a transparent material.

The term “at least translucent” refers to a material that allows at least some light incident on one surface thereof to pass through the material and exit the opposite surface wherever it is unobstructed.

The term “modified synthetic or naturally occurring nucleic acid” refers to a variety of polymer molecules that contains a base moiety (either natural or modified), a ribose or deoxyribose moiety (or their structural analogues) and a phosphate moiety as a monomer. Nucleotides can be linked together through their phosphate moieties and sugar moieties creating an internucleoside linkage. The base moiety of a nucleotide can be adenine-9-yl (A), cytosine-1-yl (C), guanine-9-yl (G), uracil-1-yl (U), and thymin-1-yl (T). The sugar moiety of a nucleotide is a ribose or a deoxyribose. The phosphate moiety of a nucleotide is pentavalent phosphate. A non-limiting example of a nucleotide would be 3′-AMP (3′-adenosine monophosphate) or 5′-GMP (5′-guanosine monophosphate).

A nucleotide analog is a nucleotide which contains some type of modification to either the base, sugar, or phosphate moieties. Modifications to nucleotides are well known in the art and would include for example, 5-methylcytosine (5-me-C), 5-hydroxymethyl cytosine, xanthine, hypoxanthine, and 2-aminoadenine as well as modifications at the sugar or phosphate moieties.

Nucleotide substitutes are molecules having similar functional properties to nucleotides, but which do not contain a phosphate moiety, such as peptide nucleic acid (PNA). Nucleotide substitutes are molecules that will recognize nucleic acids in a Watson-Crick or Hoogsteen manner, but which are linked together through a moiety other than a phosphate moiety. Nucleotide substitutes are able to conform to a double helix type structure when interacting with the appropriate target nucleic acid.

It is also possible to link other types of molecules (conjugates) to nucleotides or nucleotide analogs to enhance for example, cellular uptake. Conjugates can be chemically linked to the nucleotide or nucleotide analogs. Such conjugates include but are not limited to lipid moieties such as a cholesterol moiety. (Letsinger et al. (1989) Proc. Natl. Acad. Sci. USA, 86: 6553-6556).

Functional nucleic acids are nucleic acid molecules that have a specific function, such as binding a target molecule or catalyzing a specific reaction. Functional nucleic acid molecules can be divided into the following categories, which are not meant to be limiting. For example, functional nucleic acids include antisense molecules, aptamers, ribozymes, triplex forming molecules, and external guide sequences. The functional nucleic acid molecules can act as affectors, inhibitors, modulators, and stimulators of a specific activity possessed by a target molecule, or the functional nucleic acid molecules can possess a de novo activity independent of any other molecules.

Functional nucleic acid molecules can interact with any macromolecule, such as DNA, RNA, polypeptides, or carbohydrate chains. Thus, functional nucleic acids can interact with the mRNA of a target protein or the genomic DNA of a target protein or they can interact with the target protein. Often functional nucleic acids are designed to interact with other nucleic acids based on sequence homology between the target molecule and the functional nucleic acid molecule. In other situations, the specific recognition between the functional nucleic acid molecule and the target molecule is not based on sequence homology between the functional nucleic acid molecule and the target molecule, but rather is based on the formation of tertiary structure that allows specific recognition to take place.

A Watson-Crick interaction is at least one interaction with the Watson-Crick face of a nucleotide, nucleotide analog, or nucleotide substitute. The Watson-Crick face of a nucleotide, nucleotide analog, or nucleotide substitute includes the C2, N1, and C6 positions of a purine based nucleotide, nucleotide analog, or nucleotide substitute and the C2, N3, C4 positions of a pyrimidine based nucleotide, nucleotide analog, or nucleotide substitute.

A Hoogsteen interaction is the interaction that takes place on the Hoogsteen face of a nucleoside or nucleoside analog, which is exposed in the major groove of duplex DNA. The Hoogsteen face includes the N7 position and reactive groups (NH₂ or O) at the C6 position of purine nucleotides.

The term “probe” refers to a molecule that is capable of interacting with a target molecule or molecule of interest. If the target molecule is a nucleotide sequence, then the interaction can occur in a sequence specific manner; that is, through hybridization, for example. In this aspect, a probe can typically be made from any combination of nucleotides or nucleotide derivatives or analogs available in the art.

The term “etching” refers to the process of removing the exposed cladding layer material to expose the underlying substrate. There are generally two types of etching methods known in the art: wet etching and dry etching. Examples of compounds for the wet etching solution include H₂SO4, H₃PO₄, H₂O₂, HF, HCl and NH₄OH. In the dry etching method, the etching is performed by using a gas, primarily plasma. Well-known dry etching methods include, for example, reactive ion etching (RIE) and ashing.

In effect, the plasma treatment is very similar to the dry etching method. For instance, the plasma treatment for modifying the exposed surface of the slides can be based on RIE or ashing. Examples of a gas for use in the plasma treatment include oxygen, fluorine, argon, chlorine and mixtures of at least two of these gases.

Treatment with plasma is very similar to the dry etching method. For instance, the plasma treatment for modifying the exposed surface is based on RIE or ashing. Examples of a gas for use in the plasma treatment include oxygen, fluorine, argon, chlorine and mixtures of at least two of these gases. Preferably, oxygen or fluorine is used, and more preferably, a mixture of oxygen and fluorine is used.

The term “interrogation” refers to the process or step in a process in which a sample is introduced to a microarray platform, so that all sensing zones on the platform are exposed to the sample.

The term “sensing zone” refers to a discrete area on a microarray platform that serves as an operative locus for an experiment to which the microarray is directed. For example, in a microarray of sensing zones directed to detection of one or more molecules of interest in a sample, each molecule of interest that encounters an appropriate sensing zone will undergo a chemical interaction in that zone, the product of which can be detected by appropriate analytical techniques. The manifestation of this interaction that is detected by these techniques is referred to herein as a “detection signal.” The nature of this signal depends on the interaction chosen. A typical example is the emission of electromagnetic energy such as photons of visible light or particles emitted as a product of radioactive decay. The intensity of emission serves as a measure of the prevalence of the underlying interaction, and therefore of the amount of the molecule of interest present in the sample.

The term “noise” as used herein refers to other information acquirable from a microarray that can arise from a number of non-detection phenomena such as electrical noise, mechanical vibration, and thermal noise. These can interfere with the detection, recognition, or analysis of the detection signal.

The term “background noise” or “background signal” refers to a particular type of noise that is in the same mode as the detection signal, but is the product of interactions outside of the sensing zones. An example of background signal in fluorescence-based detection would be fluorescence given off by labeled molecules in the interstices of the array.

The term “functionalization” as used herein refers to the process of making a sensing zone capable of detecting a molecule of interest, for example by attaching a ligand in the zone that can either serve to attach to a molecule of interest, either directly or via a probe molecule, thereby removing it from suspension in the sample and immobilizing it in the sensing zone. Such a ligand, either alone or bound to a probe, is referred to interchangeably herein as a “functionalizing ligand” or an “immobilization agent.”

For example, the substrate can be modified to bind DNA. In many cases, the DNA is also modified with a functional group that specifically reacts with the functional group on the substrate. Table 1 contains a list of common surface modifications and corresponding DNA modifications.

TABLE 1
Modifications to the Surface of the Substrate
to Bind Modified and Unmodified DNA

| DNA Modification | Substrate Modification |
|---|---|
| None | Polylysine |
| | Amine |
| | Epoxy |
| | Diazonium ion |
| | SU-8 |
| | Unmodified glass |
| | Agarose film |
| | Membrane |
| Silanes | Unmodified glass |
| Thiols (—SH) | Gold |
| | Mercaptosilanes |
| | Maleimide |
| | Iodoacetyl |
| Amines (—NH₂) | Aldehydes |
| | Epoxy |
| | Isothiocyanate |
| Phosphates (PO₃—) | Animated surfaces |
| Biotin | Avidin |

The term “about” when referring to a numerical value or range is intended to encompass the values resulting from experimental error that can occur when taking measurements.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

### B. Methods of Making and Using Microarrays

It is recognized that the use of microarrays in molecular analysis can benefit from higher density platforms having a greater number of sensing zones in a single platform the size of a microscope slide. DNA microarrays can be roughly divided into the two types according to the fabricating methods: photolithographed-type and spotted-type. Photolithographed-type DNA microarrays are typically made by synthesizing a large number of DNA (oligonucleotides) with different base sequences on a support by the photolithography technology used in the fabrication of semiconductor integrated circuits. Spotted-type DNA microarrays are created on a substrate by “spotting” the substrate with a preparation of the probe or functional ligand. That is, a very small volume of the substance is applied to the surface of the substrate in a number of places to create an array of “spots.” Since spotted-type microarrays are fabricated by spotting droplets containing probe DNA on a support and drying up, the density and uniformity of the DNA probes attached to the support are not assured. In other words, with this method it is difficult to control the eventual sizes of each spot, and the DNA detection spots are not uniform in size and shape. These differences in size cause, in turn, a variation in the amounts of DNA attached to the spots.

Not surprisingly, the variation in the size distribution of sensing zones is one of the limiting factors in this approach for the fabrication of high density arrays. Also, with very small sensing zones arranged in dense arrays, it is difficult to restrict the placement of substances to within the boundaries of the zones themselves. These factors lead to a number of problems, including compromised addressability due to crosstalk between sensing zones, high levels of background noise in the fluorescence signature, and lack of reproducibility in results. For these reasons, spotted-type microarrays can be used only for qualitative analysis, and is not suitable for quantitative analysis. That is, by spotted-type microarrays, it is possible to detect the presence of detection spots at which a target biomolecule is hybridized to the probe, but not possible to measure the amount of the target biomolecule hybridized at each spot. Further, target biomolecules nonspecifically attach to the surface of the microarray around the detection spots because of the presence of the immobilizing agent and cause a decrease in the S/N ratio of measurement by increased noise.

Hence, it is particularly important to consider the effects of crosstalk between the zones in the high-density format, where molecular features destined to one address on the surface may react with proximal secondary zones. Prefabrication of the sensing zones having the desired size and shape using thin-film cladding, as well as surface-specific immobilization techniques addresses such problems.

The present invention provides a method of making high-density microarray platforms, in which an array of sensing zones is fabricated in a cladding layer. By using photolithography and other techniques such arrays can feature a very high number of small sensing zones, all of uniform shape and volume. In addition, it has been found that carefully using a cladding layer material can allow functionalizing ligands to be placed so that they are restricted solely to the sensing zones, thereby reducing extraneous activity in surrounding areas. Therefore a method of making a high-density microarray can comprise applying a thin film cladding layer to a substrate. The substrate may be of any material compatible with the application of thin films by methods known in the art. Examples of suitable substrate materials include glass, quartz, and silicon. Alternatively, substrates can comprise membranes made from polymers such as cyclic olefin copolymer (COC), polycarbonate (PC), polymethyl methacrylate (PMMA), polydimethylsiloxane (PDMS), oxidized silicon and fused silicon. Theoretically there is no limitation on the size of the substrate to be used. Preferably, the size should be chosen which is appropriate for the eventual method of analysis to be employed. A typical approach involves mounting the microarray onto a microscope stage for purposes of illumination, irradiation, or observation. Therefore a preferred embodiment will utilize a substrate size that can be so mounted. In a particular embodiment, a standard 7.5 cm×2.5 cm glass microscope slide serves as the substrate.

In one aspect of the invention, the cladding layer should be made from a material that can be patterned with conventional photolithography techniques. The material for the cladding layer may be a metal, a dielectric, hydrogel, or a semiconductor. Hydrogels are a network of polymer chains that are water-insoluble, sometimes found as a colloidal gel in which water is the dispersion medium. Suitable metals for the cladding layer include but are not limited to silver, aluminum, gold, chromium, copper, nickel, titanium, and platinum. Suitable dielectrics include metal oxides, non-metal oxides, metal sulfides, and non-metal sulfides. While a number of combinations of cladding material and substrate material are possible in accordance with this invention, skilled artisans will appreciate that certain combinations may be preferred to gain the full benefit of some microarray applications. In a particular embodiment of this invention, the ability of a potential cladding layer material to form chemical bonds with certain molecules is also a basis for selecting or rejecting the material. In other aspects, a cladding layer material may be chosen for desirability of other characteristics based on the detection techniques to be employed with the microarray. In a particular embodiment, a dielectric cladding layer material is used that can be made opaque (i.e., absorptive) with regard to a broad spectrum of light or to the particular wavelengths used to analyze the array.

The cladding layer material is deposited onto the substrate as a thin film. In a specific embodiment, this thin film has a thickness of from about 30 nm to about 100 nm. The deposition of the cladding layer may be accomplished by methods known in the art. The methods by which a metal cladding layer may be applied include thermal spray coating, vapor deposition, and chemical vapor deposition, or sputtering. Once deposited, the cladding layer becomes the medium in which the desired number of sensing zones may be created.

The present invention provides for the creation of sensing zones of a desired size, shape, and arranged in a desired density. In particular, high-density arrays are achievable in which hundreds to hundreds of thousands of sensing zones are contained on one microscope-mountable platform. Accordingly, the sizes of the sensing zones in a particular embodiment can range from about 0.1 μm to about 100 μm. The sensing zones may arranged in a regular and periodic array in which the center-to-center distance between each zone and the zones immediately adjacent to it is substantially constant across the array. In one such embodiment, the interstices can range from about 0.15 μm to about 150 μm.

Alternatively, the sensing zones may be arranged in an array that has an aperiodic or even random pattern. In that case, the sizes of the interstices will fall along a distribution in which the minimum is about 0.15 μm. A shape may be chosen for the sensing zones according to anticipated needs. For example, it may be desirable to use sensing zones having the same shape as the pixel elements of an imaging device used to image the signal produced by a detection assay. Zone shapes in accordance with the present invention may be circular, elliptical, or a 3- to 20-sided polygon.

Photolithography techniques may then be used to pattern the cladding layer to create an array of sensing zones of the desired shape and size. Photoresist may be deposited onto the cladding layer, and then exposed to a pattern of radiant light energy that will cause selective curing of the resist according to that pattern. The desired pattern of irradiation may be achieved by interposing a mask having that pattern between the radiant light energy source and the cladding layer surface. The types of radiant light energy that activate the resist include but are not limited to ultraviolet light, electrons, x-rays, electromagnetic fields, an acoustic source, a thermal source, a chemical course, a plasma source, and an ion bombing source.

According to one embodiment, positive photoresist is applied to the cladding layer, and a mask is chosen so that only the intended locations of the sensing zones are irradiated with a beam having the cross-sectional shape of the intended zones. Upon development of the photoresist, the underlying cladding layer will be exposed at the locations of sensing zones. The exposed cladding layer material is then etched away with standard etching methods (e.g., wet, dry, or ion beam) to expose the underlying substrate. Finally, the remaining photoresist is removed, revealing an array of wells or cavities, the boundaries of which are defined by the remaining cladding layer (“well” sensing zones).

In an alternate embodiment, sensing zones are produced that are islands of cladding layer material (“island” sensing zones), rather than wells etched out of it. In this embodiment, negative photoresist is applied to the cladding layer, and then irradiated as described above. After development of the photoresist, dissolution of the exposed cladding layer, then removal of the remaining photoresist, an array of sensing zones made of cladding layer material results. In either of these embodiments, the resulting sensing zones are highly uniform in shape and size, facilitating more accurate and reliable quantitative analysis of results, particularly when compared to conventional spotted microarrays.

In addition to dense arrays of uniform sensing zones, the method of the present invention also provides for more effective functionalization of the sensing zones. As discussed above, microarrays can be prepared for use in detecting organic molecules by effecting the attachment of appropriate molecules to the microarray. In many cases, a functionalizing ligand is utilized to effect this attachment. Then an appropriate assay may be carried out to ascertain the presence and quantity of molecules of interest in a sample introduced to the microarray. For example, in a DNA detection microarray, oligonucleotide probes are attached to the microarray. When a fluorescence labeled nucleic acid polymer sample is interrogated by the microarray, only the polymers that hybridize to the probes remain on the microarray. Application of excitation light causes the bound label to fluoresce and the corresponding sequences can then be detected and identified by their location.

In a similar fashion, a microarray can be used to assay for other types of organic molecules by functionalizing its sensing zones with a ligand configured to immobilize molecules of interest on the array surface. Functionalizing agents should be chosen that can both attach to the material of the sensing zone and can immobilize the target molecule. This often means that a suitable ligand will have at least two sets of functional groups: (1) one or more basal groups by which it can attach to the sensing zone, and (2) one or more apical groups configured to interact with the target molecule. In “well” sensing zone embodiments, where the functional surface of the sensing zone comprises exposed substrate, the functionalizing agents should be suited for use with the substrate material. Glass substrates, for example, can be functionalized by depositing organosilanes on the glass via wet chemistry or vapor deposition to form a thin layer of functionalized silanes. The silanes are bound to the glass through silicon-oxygen bridges created by reaction of the silanol groups of the glass with basal functional groups of the silanes. Organosilanes include but are not limited to carboxysilane and aminosilane. There is also the inserting of various lengths of alkyl spacers to alleviate steric hindrances and surface effects. In another aspect, the functional silanes (amino- or carboxy-) are mixed with relatively inert silanes, such as alkyl-, PEG-, or hydroxy-silanes. Mixed silanes may result in greater binding efficiency/surface density in subsequent layers.

Alternatively, polymer substrates can be functionalized by a number of approaches known in the art. With PMMA, these often involve chemical modification of the polymer's intrinsic functional groups to yield an aminated surface. Similarly, in “island” sensing zone embodiments, functionalizing agents should have basal groups suited for attachment to the cladding layer material. Once attached, the silanes should present apical groups that will interact with the target molecule. For example, agents having thiol, amine, aldehyde, epoxy, semicarbazide, and diazonium functional groups may be used to immobilize DNA fragments. Where needed, the apical group may be further modified by a linker.

A potential difficulty with using high-density microarrays with these approaches is that often agents used to functionalize sensing zones may also attach in appreciable quantities in the interstices. This is a significant issue because of the way in which microarrays are typically used to interrogate a sample. That is, the sample, which often comprises a solution in which various putative targets are suspended, is introduced to the entire array so both the sensing zones and the interstices are exposed to target molecules. Any target molecules that bind outside the sensing zones may, upon illumination and image acquisition, result in a spurious background signal that makes quantifying the detection signal and addressing individual zones difficult. However, microarrays made according to the present invention may be functionalized so as to minimize these problems. This is possible both with “well” sensing zones and with “island” sensing zones.

For example, in “well” sensing zone embodiments, a combination of cladding layer material and functionalizing agent may be chosen in which the functionalizing agent attaches with high affinity to the substrate material inside the sensing zones, while being inert with regard to the surrounding cladding layer material. The result is that in such a microarray, attached functionalizing agent is found exclusively within the sensing zones, while the cladding layer that constitutes the rest of the microarray's upper surface is substantially free of any attached functionalizing agent. In embodiments having “island” sensing zones, a preferred combination is a functionalizing agent that attaches to the chosen cladding layer material with high affinity, while being inert with regard to the exposed substrate material that constitutes the rest of the upper surface of the microarray. The result here is also that attached functionalizing agent is found exclusively on the sensing zones, while the rest of the upper surface of the microarray is substantially free of functionalizing agent.

According to another embodiment of this invention, the microarray can be functionalized with an agent having functional groups for which interaction with microarray material and/or target molecules is light-dependent. In a particular aspect of this embodiment, the agent chosen attaches to a microarray surface primarily via a photolabile functional group that has absorbed light. In an alternate aspect, the agent has functional groups that are protected by agents that are bound to the groups by photolabile bonds. In either aspect, the functionalizing agent does not form a bond with the microarray surface unless it is exposed to sufficient incident light. By applying a solution of functionalizing ligand to the microarray, then providing patterned excitation illumination, such as through a mask, so that only the sensing zones are illuminated, attachment by the ligand can be substantially restricted to the sensing zones. Unlike commonly used methods in which the photolabile protection groups are linked to the molecules in solution, the photo labile protection groups here are attached to the molecular features immobilized on the surface. This approach insures that the reactive moieties are generated only in the addressable spots on the surface after applying a specially and temporally structured excitation (e.g., UV or visible light). This approach improves the addressability of the sensing zones.

Photolysis offers a mild and potentially orthogonal method of cleavage that takes place under neutral conditions. In carbohydrate chemistry and nucleotide and peptide synthesis, photocleavable protecting groups have enjoyed widespread use. From synthetic point of view, PPGs are orthogonal to other protecting groups and do not require reagents or heating for their removal. The use of photocleavable protecting groups has been limited in non-oligomeric syntheses limited by (1) the fact that many small organics absorb light, (2) the fact that many small organics are sensitive to the irradiation needed to cleave the linker, and (3) concerns about the rates of photolysis and the yields. Thus, to achieve good yields for cleavage, the light used should only be absorbed by the linking group, and further should not affect other groups if possible.

The list of acceptable photocleavable linkers includes but is not limited to (1) o-Nitrobenzyl-based linkers (ONB), (2) Phenacyl linkers, (3) Alkoxybenzoin linkers, (4) NpSSMpact linkers, (5) Pivaloylglycol linkers, and (6) miscellaneous photolytic protocols. ONB linkers include but are not limited to ONB linkers, α-substituted ONB linkers, photocleavable linkers for aldehydes, and nitroveratryl linkers. Phenacyl linkers include but are not limited to α-methylphenacyl. Alkoxybenzoin linkers include but are not limited to Benzoin esters and 3-alkoxy-protected benzoin linkers. Miscellaneous photolytic protocols include but are not limited to protocols that utilize chromium arene complexes and triphenylphosphines. Guillier et al., 2000 presents a detailed review of several types of linkers including photocleavable linkers. In its entirety, Guillier et al., 2000 is herein incorporated into this application.

Decreasing the level of noise due to extraneous fluorescent label can make results of analysis less ambiguous and therefore more easily interpreted. An added effect is increased power of the analysis to resolve a signal that is weak, such as when a sample is very small, the molecule of interest is present in very low quantities, or the affinity between the molecule and the immobilizing agent is low. In addition to controlling where functionalizing ligands attach in a microarray, decreasing unwanted background signal can also be accomplished by restricting immobilization of target molecules to the sensing zones. In this way, any functionalizing agent that happens to be located in the interstices of an array will not produce background signal, due to lack of interaction with target molecules in the sample. Accordingly, in another embodiment of the present invention, a functionalizing agent binds with target molecules in a light-dependent manner. For example, the apical functional groups of a functionalizing ligand can be blocked or protected by a protecting group that is photolabile or is attached to the ligand by photolabile bonds.

Another approach to achieving this is to use the structure of the microarray itself to restrict illumination to desired areas, thereby enhancing the benefits of using photo-dependent functionalization ligands. In this approach, illumination used to facilitate ligand interactions is delivered from below the microarray rather than from above, so that the microarray serves the function of an illumination mask. According to this embodiment, a substrate material is chosen that is at least translucent, so that at least some light incident on one surface thereof will pass through the substrate material and exit the opposite surface wherever it is unobstructed. Preferably the substrate material is substantially transparent to light having a range of wavelengths including those in the ultraviolet range, visible range, or both. At the same time a cladding layer material is chosen that is opaque to these wavelengths when applied as a thin film. When such a substrate serves as a support for a “well” microarray as described above, and is illuminated from a light source underneath, light only passes through its upper surface at the sensing zones. Therefore, when a functionalizing agent that only attaches to the substrate in the presence of light is applied to the upper surface of the microarray illuminated in this way, it will only attach within the sensing zones. The surrounding cladding material, on the other hand, does not admit the light to its upper surface so that the functionalizing agent fails to attach to it. After washing, the microarray is only functionalized at the sensing zones, while the rest of the upper surface of the microarray is substantially free of functionalizing agent. In another aspect of this embodiment, a well microarray that has already been functionalized with an immobilization agent that will bind to targets in a light-dependent manner may be used to interrogate a sample while illuminated from below. The target molecules in the sample, although exposed to the entire microarray, will be preferably immobilized in the sensing zones.

Microarrays of the present invention, once presented with a sample, may also be analyzed by delivering exciting illumination from below, so that labeled targets in sensing zones are detected while those in the interstices are not. In this approach, the microarray should comprise a substrate that is at least somewhat transparent to the exciting wavelengths of the light. In a more particular embodiment, the cladding layer should be substantially opaque to those wavelengths. The cladding layer, wherever it is present, prevents the exciting light from passing through the upper surface of the microarray. Therefore, any photolabeled molecules of interest that may be attached to the cladding layer will not have their labels excited by the light and will not be detected upon analysis. This is in contrast to the conventional approach of illuminating the array from above, where any label situated outside the sensing zones will be excited and contribute noise in analysis. Only the molecules that are immobilized in the sensing zones will contribute to the detection signal, providing an increase in signal-to-noise ratio.

The above approaches to controlling how a microarray is exposed to excitation light are enhanced by the use of appropriate cladding layer material. For example, in some cases a cladding layer made from a reflective material may cause areas outside of the sensing zones to be exposed to stray reflected light. Furthermore, excitation light incident on the array may be subject to substantial diffraction at cladding layer edges, such as the edges laterally defining the sensing zones in “well” embodiments. Accordingly, a particular embodiment of the present invention comprises a cladding layer made from material that is not only opaque to light, but also absorbs incident light. In a more specific embodiment, the cladding layer material is a dielectric that is opaque and absorptive.

Microarrays, by virtue of having multiple sensing zones, allow for the parallel testing of samples against a number of probes or types of ligands. Where each probe or ligand is localized to a particular sensing zone, the zones that give a detection signal in response to a sample also give an indication to the identity of the molecule(s) of interest in the sample. Therefore the detection signal produced on a microarray provides both information about amount of target molecule in the sample (by intensity of signal) and the identity of the molecule (location of signaling sensing zones).

The present invention also provides for a method of making microarrays in which each sensing zone itself include an addressable array. One embodiment is an array of well sensing zones each of which contains an array of smaller well sensing zones. Another embodiment provides an array of well sensing zones in which each well contains an array of island sensing zones. Still another embodiment provides an array of island sensing zones, each of which containing an array of smaller island sensing zones. Alternatively, an island can be configured to include a plurality of smaller wells. One way such arrays can be made is by adding another photolithography iteration to the methods disclosed herein. In many cases, each sub-feature can include the same ligand; however, in some cases, different ligands can be included within each sub-feature (e.g., a microarray of microarrays). Such a system may be prepared using light activated techniques.

### EXAMPLES

### Example 1

### Preparation of Microarray with Wells

A 50 nm-thick gold cladding layer is applied to the upper surface of a standard glass microscope slide by chemical vapor deposition or sputtering. Positive photoresist is spin-coated onto the cladding layer and heated to drive off any remaining solvent. Upon cooling, the photoresist is exposed to UV radiation applied through a mask bearing an array of round holes, so that the radiation incident on the surface consists of an array of round spots having a diameter of 8 μm with center-to-center spacing of 10 μm. Exposure is maintained for a suitable amount of time to cause the photoresist to be sufficiently exposed to generate the material modification. The slide is then washed to remove any soluble resist. The result is an array of holes in the resist having the same dimensions and spacing as the UV light spots and within which the gold cladding layer is exposed. The exposed gold is etched away, followed by removal of the cured photoresist, to produce a microarray of circular well-like sensing zones surrounded by gold cladding.

### Example 2

### Preparation of Microarray with Islands

In another preferred embodiment, the substrate is glass and the cladding layer is a metal such as Au of 50 nm thickness. The Au layer is etched, leaving behind round “islands” of 8 micron diameters and 10 micron spacings. The regions between islands are glass. Attachment of the molecular probes to the islands can occur through thiol-active methods [include protein disulphide bonds].

### Example 3

### Immobilization of Probe Molecules within the Sensing Zones

The slides are exposed to an RF induced oxygen at 400 mTorr in a March Plasmod for 5 minutes. This chemically modifies the exposed glass in the microarray wells and leaving the gold cladding inert. After the oxygen plasma the slides are immediately placed in a vapor deposition chamber containing 0.5 ml of 3-glycidoxypropyldmethylethoxysilane (GPS). The chamber is pumped down to 3 mTorr and heated to 115° C. which allows the GPS to vaporize and attached to the modified microarray well surfaces. After 16 hours in the vapor deposition chamber the slides are removed and to be spotted with oligonucleotide probes or stored for use at a later time. Immobilization is done with the oligonucleotide probes in a phosphate buffer at 150 mM with a pH of 8.5. An aliquot of probe is placed on the desired microarray well for 30 minutes at room temperature in a humid chamber followed by 30 minutes at 75° C. in a humid chamber. After the two 30 minute incubations the slides are rinsed and ready for hybridization.

### Example 4

### Immobilization of Photolabile Probe Molecules within the Sensing Zones

In yet another preferred embodiment, the substrate is glass and the cladding layer is a metal such as aluminum (Al) of 50 nm thickness. Round features of 8 micron diameters are etched into the Al layer with 10 micron center to center spacings. An example of this embodiment is shown in the following figure. Light-activated probe attachment or in-situ probe synthesis can be performed by illuminating from underneath so that light only transmits through the open windows so that attachment and/or synthesis only occurs at the glass surface of each window. All windows can be illuminated simultaneously, or one at a time.

### Example 5

### Analysis of Sample

In a typical experiment a microarray (substrate with adequate surface modifications) is exposed to a reaction chamber by applying a sealed cover or microfluidic conduit made of appropriate materials (glass with sealing spacer, polystyrene, PDMS as examples). Sample is introduced into the chamber and reaction between surface ligands and sample components (targets) is allowed to proceed for a desired period of time. After completion of reaction, the reaction chamber is disassembled and the sensing surface of the microarray is “washed” (actual procedures may vary depending on the type of microarray) to remove traces of the sample and components which adhere to the surface in a non-specific manner. After that the array is placed in a detecting device (in case of fluorescent labels in a scanner), which allows to record signals and align signal positions with the sensing zones positions (i.e., addressable output). Signal intensities are then interpreted in terms of quantitative analysis of the sample composition. Alternatively, signal acquisition may be accomplished as a real-time change of the surface characteristics (capacitance, refractive index, surface bound fluorescence) which can also provide information on the quantitative composition of the sample.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

### REFERENCES

1. Dufva. (2005) Fabrication of high quality microarrays. Biomolecular Engineering, 22: 173-184.
2. Guillier et al. (2000) Linkers and cleavage strategies in solid-phase organic synthesis and combinatorial chemistry. Chem. Rev., 100: 2091-158.
3. Kai et al. (2003) Protein Microarray on Cyclic Olefin Copolymer (COC) for Disposable Protein Lab-on-a-Chip, presented at the 7^{th} International Conference on Miniaturized Chemical and Biochemical Analysis Systems, Oct. 5-9, 2003, Squaw Valley, Calif.
4. Letsinger et al. (1989) Cholesteryl-conjugated oligonucleotides: synthesis, properties, and activity as inhibitors of replication of human immunodeficiency virus in cell culture. Proc. Natl. Acad. Sci. USA, 86: 6553-56.
5. European Patent Application No. 01127937.9, published as EP 1 208 909 A2, titled Biomolecule microarray support, biomolecule microarray using the support, and method of fabricating the support, published on May 29, 2002, filed on Nov. 23, 2001, by Riken and Waseda University, invented by Tashiro et al.
6. United States Patent Application No. 2006/0154242, titled Biomolecule Chip and Fabrication Method Thereof, published on Jul. 13, 2006, filed on Jan. 10, 2006, by Kim et al.
7. U.S. Pat. No. 6,114,099, titled Patterned Molecular Self-Assembly, issued to Liu and Schick, on Sep. 5, 2000.

What is claimed is:

1. A method of making a microarray, comprising:
a. providing a substrate that is at least translucent having at least an upper surface and a lower surface;
b. depositing a cladding layer material onto the upper surface of the substrate so as to create a cladding layer on the substrate;
c. etching an array of sensing zones into the cladding layer, each sensing zone being a discrete area in which the cladding layer has been removed to expose the underlying substrate;
d. applying to the array of sensing zones a ligand having an apical functional group and a photolabile functional group, wherein the photolabile functional group requires radiant light energy in order to bind to a surface; and
e. irradiating the lower surface of the substrate with radiant light energy so that the radiant light energy passes through the upper surface only in the sensing zones, thereby causing the ligand in the sensing zones to bind to the upper surface; wherein the bound ligand is substantially confined to the sensing zones and the cladding layer remains substantially free of bound ligand.

2. The method of claim 1, wherein the substrate is transparent.

3. The method of claim 2, wherein the radiant light energy is UV light energy.

4. The method of claim 1, further comprising the step of attaching a probe to the apical functional group of the bound ligand either before or after it is attached to the substrate.

5. The method of claim 1, wherein the ligand is a member selected from the group consisting of DNA, RNA, PNA, LNA, and other modified synthetic or naturally occurring nucleic acids, peptides, proteins, antibodies, glycans, fatty acids, enzyme substrates, activators, and inhibitors.

6. The method of claim 1, wherein the substrate comprises a material selected from the group consisting of glass, quartz, silicon, PMMA, and PDMS.

7. The method of claim 6, wherein the substrate material comprises glass.

8. The method of claim 1, wherein the cladding layer material comprises a member selected from the group consisting of gold, copper, aluminum, chromium, nickel, silver, titanium, and platinum, and alloys thereof.

9. The method of claim 8, wherein the cladding layer material comprises gold.

10. The method of claim 8, wherein the cladding layer material comprises aluminum.

11. The method of claim 1, wherein the cladding layer material comprises a dielectric material selected from the group consisting of metal oxides, nonmetal oxides, metal sulfides, nonmetal sulfides, and combinations thereof.

12. The method of claim 1, wherein the cladding layer material is substantially opaque.

13. The method of claim 1, wherein the cladding layer material comprises a crystalline or non-crystalline semiconductor material.

14. The method of claim 1, wherein the microarray is used to obtain quantitative information about the composition of a sample.

15. The method of claim 1, wherein the photolabile functional group is immobilized in the sensing zone, wherein radiant light energy de-protects the photolabile functional group, wherein the de-protected photolabile functional group can bind to an oligonucleotide probe or other biomolecule.

16. A method of making a microarray, comprising:
a. depositing a cladding layer material onto a substrate so as to create a cladding layer on the substrate;
b. etching an array of sensing zones into the cladding layer, each sensing zone having a shape and being located at a discrete area in which the cladding layer has been removed to expose the underlying substrate; and
c. applying a ligand having a basal functional group and an apical functional group to the array of sensing zones, wherein the basal functional group is configured to bind to the substrate but not to the cladding layer material, so that bound ligand is substantially confined to the sensing zones and the cladding layer remains substantially free of bound ligand.

17. The method of claim 16, further comprising the step of attaching a probe to the apical functional group of the bound ligand.

18. The method of claim 16, wherein the ligand is a member selected from the group consisting of DNA, RNA, PNA, LNA, and other modified synthetic or naturally occurring nucleic acids, peptides, proteins, antibodies, glycans, fatty acids, enzyme substrates, activators, and inhibitors.

19. The method of claim 16, wherein the substrate comprises a substrate material selected from the group consisting of glass, quartz, silicon, PMMA, and PDMS.

20. The method of claim 19, wherein the substrate material comprises glass.

21. The method of claim 16, wherein the cladding layer material comprises a member selected from the group consisting of gold, copper, aluminum, chromium, nickel, silver, titanium, and platinum, and alloys thereof.

22. The method of claim 21, wherein the cladding layer material comprises gold.

23. The method of claim 21, wherein the cladding layer material comprises aluminum.

24. The method of claim 16, wherein the cladding layer material comprises a dielectric material selected from the group consisting of metal oxides, nonmetal oxides, metal sulfides, nonmetal sulfides, and combinations thereof.

25. The method of claim 16, wherein the cladding layer material is substantially opaque.

26. The method of claim 16, wherein the cladding layer material comprises a crystalline or non-crystalline semiconductor material.

27. A method of making a microarray, comprising:
a. depositing a cladding layer material onto a substrate so as to create a cladding layer on the substrate;
b. patterning an array of sensing zones onto the cladding layer;
c. removing the cladding layer material outside of the sensing zones to expose the underlying substrate, so that each sensing zone comprises a discrete area of cladding layer material surrounded by exposed substrate; and
d. applying a ligand having a basal functional group and an apical functional group to the array of sensing zones, wherein the basal functional group is configured to bind to the cladding layer material but not to the substrate material, so that bound ligand is substantially confined to the sensing zones and the substrate remains substantially free of bound ligand.

28. The method of claim 27, further comprising the step of attaching a probe to the apical functional group of the bound ligand.

29. The method of claim 27, wherein the ligand is a member selected from the group consisting of DNA, RNA, PNA, LNA, and other modified synthetic or naturally occurring nucleic acids, peptides, proteins (including but not limited to antibodies), glycans, fatty acids, enzyme substrates, activators, and inhibitors.

30. The method of claim 27, wherein the substrate comprises a material selected from the group consisting of glass, quartz, silicon, PMMA, and PDMS.

31. The method of claim 30, wherein the substrate material comprises glass.

32. The method of claim 27, wherein the cladding layer material comprises a member selected from the group consisting of gold, copper, aluminum, chromium, nickel, silver, titanium, and platinum, and alloys thereof.

33. The method of claim 32, wherein the cladding layer material comprises gold.

34. The method of claim 32, wherein the cladding layer material comprises aluminum.

35. The method of claim 27, wherein the cladding layer material comprises a dielectric material selected from the group consisting of metal oxides, nonmetal oxides, metal sulfides, nonmetal sulfides, and combinations thereof.

36. The method of claim 35, wherein the dielectric material is substantially opaque.

37. The method of claim 27, wherein the cladding layer material comprises a crystalline or non-crystalline semiconductor material.

38. A microarray, comprising:
a. a substrate;
b. cladding material deposited on the substrate in the form of an array of discontinuous islands of cladding material substantially isolated from one another by the substrate; and
c. a ligand having a basal functional group and an apical functional group attached to the islands, wherein the basal functional group is configured to bind to the cladding material but not to the substrate so that bound ligand is substantially confined to the islands and the substrate remains substantially free of bound ligand.

39. A microarray, comprising:
a. a substrate;
b. cladding material deposited on the substrate in the form of a continuous layer of cladding material that laterally defines an array of discontinuous wells, wherein a base portion of said wells includes the substrate; and
c. a ligand having a basal functional group and an apical functional group attached to the wells, wherein the basal functional group is configured to bind to the substrate but not to the cladding layer material so that bound ligand is substantially confined to the sensing zones and the cladding layer remains substantially free of bound ligand.

40. The microarray of claim 39, wherein the ligand comprises a photolabile functional group that requires radiant light energy in order to bind to a surface.

41. The microarray of claim 40, wherein the radiant light energy passes through the upper surface only in the sensing zones, thereby causing the photolabile functional group in the sensing zones to bind to the upper surface; wherein the bound ligand is substantially confined to the sensing zones and the cladding layer remains substantially free of bound ligand.

42. The microarray of claim 41, wherein the photolabile functional group is immobilized in the sensing zone, wherein radiant light energy de-protects the photolabile functional group, wherein the de-protected group can bind to an oligonucleotide probe or other biomolecule.
